(19) United States
(12) Patent Application Publication
(10) Pub. No.: US 2026/0152826 A1
(43) Pub. Date: Jun. 4, 2026

(54) COBALT BASE ALLOY, POWDER, PROCESS AND COMPONENTS

(71) Applicant: Siemens Energy Global GmbH & Co. KG, Munich, Bayern (DE)

(72) Inventors: Bernd Burbaum, Falkensee (DE); Henning Hanebuth, Pliening OT Gelting (DE); Heiko Lammers, Osnabrück (DE)

(73) Assignee: Siemens Energy Global GmbH & Co. KG, Munich, Bayern (DE)

(21) Appl. No.: 19/122,301

(22) PCT Filed: Oct. 13, 2023
(86) PCT No.: PCT/EP2023/078524

§ 371 Date: Apr. 18, 2025

(30) Foreign Application Priority Data
Nov. 2, 2022 (DE) 10 2022 211 589.9

(51) Int. Cl. C22C 19/07; B22F 10/28; B23K 26/342; B23K 101/00; B33Y 10/00; B33Y 70/00; B33Y 80/00; C23C 24/10

(52) U.S. Cl. CPC C22C 19/07; B22F 10/28; B23K 26/342; B33Y 10/00; B33Y 70/00; B33Y 80/00; C23C 24/106; B22F 2301/15; B23K 2101/001

(57) ABSTRACT

The invention relates to a cobalt superalloy having (in % by weight): carbon (C): 0.04%-0.05%; chromium (Cr): 21.0%-23.0%; tungsten (W): 7.2%-8.2%; titanium (Ti): 0.05%-0.14%; aluminum (Al): 1.7%-2.7%; tantalum (Ta): 2.9%-3.6%; yttrium (Y): 0.01%-0.03%; nickel (Ni): 11.5% bis 13.5%; hafnium (Hf): 0.45%-0.65%; cobalt (Co): 49.0%-53.0%; zirconium (Zr): up to 0.02%; boron (B): up to 0.0014%; silicon (Si): up to 0.018%.

### CROSS REFERENCE TO RELATED APPLICATIONS

This application is the US National Stage of International Application No. PCT/EP2023/078524 filed 13 Oct. 2023, and claims the benefit thereof, which is incorporated by reference herein in its entirety. The International Application claims the benefit of German Application No. DE 10 2022 211 589.9 filed 2 Nov. 2022.

### FIELD OF INVENTION

The invention relates to a cobalt-based alloy, to a powder, to processes and to components.

### BACKGROUND OF INVENTION

For turbine blades of the next generation of gas turbines, because of high thermal stress (>1373 K), a more oxidation-resistant material is required at the tips of the turbine blades.

The tip of a turbine blade, even as a new part, may also comprise a different material than the material (substrate) of the blade.

Cobalt-base superalloys for improvement of oxidation resistance are currently already being used as an additive material for repairs on blade tips (EP 3,077,572A1).

### SUMMARY OF INVENTION

The aim is an improvement in mechanical properties and oxidation resistance, with simultaneously good weldability.

It is therefore an object of the invention to solve the abovementioned problem.

The object is achieved by a cobalt-based alloy, a powder, components, and methods as claimed.

The dependent claims list further advantageous measures that may be combined with one another as desired in order to achieve further benefits.

### DETAILED DESCRIPTION OF INVENTION

The description merely constitutes working examples of the invention.

The concept is that of a cobalt-based alloy which is weldable in particular and comprises, especially consists of (in % by weight):
carbon (C): 0.4% to 0.5%
chromium (Cr): 21.0% to 23.0%
tungsten (W): 7.2% to 8.2%
titanium (Ti): 0.05% to 0.14%
aluminum (Al): 1.7% to 2.7%
tantalum (Ta): 2.9% to 3.6%
yttrium (Y): 0.01% to 0.03%
nickel (Ni): 11.5% to 13.5%
hafnium (Hf): 0.45% to 0.65%
cobalt (Co): 49.0% to 53.0%,
optionally
zirconium (Zr): up to 0.02%
boron (B): up to 0.0014%
silicon (Si): up to 0.018%.

A further advantageous alloy comprises, especially consists of (in % by weight):
carbon (C): 0.45%
chromium (Cr): 22.0%
tungsten (W): 8.0%
titanium (Ti): 0.1%
aluminum (Al): 2.2%
tantalum (Ta): 3.25%
yttrium (Y): 0.02%
cobalt (Co): 50.93%
nickel (Ni): 12.5%
hafnium (Hf): 0.55%.

Carbon (C) is added, which, in addition to its function as a deoxidizing element, has further functions for combination with titanium (Ti) and tantalum (Ta) for the purpose of formation of stable MC-type primary carbides, in order to suppress the coarsening of austenitic grains during hot forming and improve hot slidability. The desired effect of the carbon (C) is achieved.

Silicon (Si) can preferably optionally be added as a deoxidizing agent and simultaneously acts to improve the adhesion of an oxide layer as it forms. However, excessive addition thereof causes a decrease both in hot formability and in ductility at room temperatures.

Chromium (Cr) forms an oxide layer with very close adhesion to the surface during heating to high temperatures, and improves oxidation resistance. In addition, chromium (Cr) can also improve hot formability.

Tungsten (W) is an additional element that essentially strengthens the austenitic solid solution up to high temperatures.

Aluminum (Al) is an additional element which is essential for formation of a stable γ′ phase after annealing treatment.

A portion of the titanium (Ti) is combined with carbon (C) to form a stable MC-type primary carbide, and has a strength-increasing function in the case of non-γ′-hardened alloys.

The remainder of titanium (Ti) is in the γ′ phase in the solid solution state, which results in strengthening of the γ′ phase, and serves to improve high-temperature stability.

Moreover, aluminum (Al), tantalum (Ta) and titanium (Ti) also have an important function in improving oxidation stability; particularly in the combination of the elements, they form stable oxide layer systems.

In the same way as titanium (Ti), a portion of both tantalum (Ta) and carbon (C) are combined to form stable MC-type primary carbides, and they have strength-increasing functions, particularly for non-γ′-hardened alloys.

Zirconium (Zr) and boron (B) are effective for optional improvement of high-temperature strength and ductility by virtue of their grain boundary-active function, and at least one of them can be added to the alloy of the invention in an appropriate amount. The effect thereof is obtained with a small added amount.

The addition of hafnium (Hf) stabilizes the grain boundaries and hence improves the mechanical properties at high temperatures.

The alloy or the powder can be used in the production of new solid components, in repairs or in the modular production of new components in which at least a section has a different chemical composition.

Coatings are likewise conducted with the alloy or the powder.

A complete component, especially a turbine component, can be produced with the alloy or the powder.

The alloy or the powder can likewise be used to produce a modular new component, especially a turbine component, or else in particular a component to be repaired.

In this case, the alloy of the invention or the powder of the invention is applied to a metallic substrate in particular, which is different than the alloy or the powder and which is especially a nickel-based alloy, especially by means of cladding.

What is meant generally by a “different alloy” is that at least one alloy element is present to a greater or lesser degree and/or that the proportion of at least one alloy component differs by at least 10%, especially at least by 20%.

It is possible here to use methods (new part, repair) such as cladding, especially laser cladding, very particularly laser powder cladding with or without abrasive particles, and additive methods (3D printing), especially powder bed methods, i.e. also possible with binders, or spraying methods (APS, HVOF, . . . ).

1. A cobalt superalloy, comprising, especially consisting of (in % by weight):
carbon (C): 0.4% to 0.5%
chromium (Cr): 21.0% to 23.0%
tungsten (W): 7.2% to 8.2%
titanium (Ti): 0.05% to 0.14%
aluminum (Al): 1.7% to 2.7%
tantalum (Ta): 2.9% to 3.6%
yttrium (Y): 0.01% to 0.03%
nickel (Ni): 11.5% to 13.5%
hafnium (Hf): 0.45% to 0.65%
cobalt (Co): 49.0% to 53.0%,
optionally
zirconium (Zr): up to 0.02%
boron (B): up to 0.0014%
silicon (Si): up to 0.018%.

2. The alloy as claimed in claim 1, comprising, especially consisting of (in % by weight):
carbon (C): 0.45%
chromium (Cr): 22.0%
tungsten (W): 8.0%
titanium (Ti): 0.1%
aluminum (Al): 2.2%
tantalum (Ta): 3.25%
yttrium (Y): 0.02%
cobalt (Co): 50.9%
nickel (Ni): 12.5%
hafnium (Hf): 0.55%.

3. A powder, comprising:
an alloy, especially consisting of an alloy, as claimed in claim 1,
optionally comprising binder and/or comprising abrasive particles.

4. A component, especially a turbine component, comprising:
an alloy, especially consisting of an alloy, as claimed in claim 1.

5. A component, especially a turbine component, very particularly a repaired component, comprising:
a metallic substrate, especially a nickel-based substrate, other than an alloy as claimed in claim 1, and
a portion of the component on the substrate, especially a blade tip of a turbine blade, comprising an alloy as claimed claim 1.

6. A method of producing a component, especially a turbine component, comprising:
cladding, especially laser cladding, or additive manufacturing, especially powder bed methods, using an alloy as claimed in claim 1 to produce the component.

7. A method of producing a component, especially for repair of the component, comprising:
cladding, especially laser cladding, or additive manufacturing, especially powder bed methods, using an alloy as claimed in claim 1 to repair the component.

8. The method of producing a component of claim 7,
wherein the alloy is in the form of a powder,
wherein the powder optionally comprises binder and/or abrasive particles, and
wherein the powder is applied to a substrate, especially to a nickel-based substrate.
